(19) United States
(12) Patent Application Publication
(10) Pub. No.: US 2024/0042263 A1
(43) Pub. Date: Feb. 8, 2024

(54) SELECTOR PIN OF WEIGHT STACK AND BOLT ELEMENT THEREOF

(71) Applicant: Innovated Fitness, Corp., Wilmington, DE (US)

(72) Inventors: Heikki Peltonen, Muurame (FI); Sirpa Roivas, Jyväskylä (FI); Markku Ruuskanen, Lievestuore (FI)

(21) Appl. No.: 18/266,721

(22) PCT Filed: Dec. 9, 2021
(86) PCT No.: PCT/FI2021/050858

§ 371 Date: Jun. 12, 2023

(30) Foreign Application Priority Data
Dec. 10, 2020 (FI) 20206277

(51) Int. Cl. A63B 21/062; A63B 71/06; G01G 19/52

(52) U.S. Cl. CPC A63B 21/063; A63B 71/0619; G01G 19/52; A63B 2220/52; A63B 2071/065

(57) ABSTRACT

The present disclosure describes selector pin for a weight stack of a weight exercise machine, and a bolt element for such a selector pin. The bolt element has two first contact points (22.1) positioned along the length of the bolt element (22) on a first side of the bolt element (22), and a second contact point (22.2) between the first contact points on a second side opposite to the first side. The first contact points (22.1) being configured to engage with the weight plate during an exercise, and the second contact point (22.2) being configured to engage with the centre selector shaft. The bolt element may further have a stress sensor configured to determine mechanical stress of the bolt element caused by forces generated by the weight plate and the selector shaft acting on the first and second contact points (22.1; 22.2) of the bolt element (22).

### FIELD

The invention relates to monitoring physical exercise, and in particular, to monitoring a physical exercise performed in a weight exercise device.

### BACKGROUND INFORMATION

There are a large variety of devices for physical exercise. These devices allow exercises to be performed in controlled, consistent, repeatable manner. However, conventional exercise devices typically lack the ability of monitoring and recording the quality and progress of the exercise. One convention way of keeping track of the progress is the use of a pencil and a paper. However, this may be tedious and error-prone and requires the user to carry pencil and paper along. It may be very difficult for users of exercise devices to monitor their own performance during the exercise.

In order to alleviate these problems, various approaches have been presented. Many of these approaches involve implementing smart functionalities to the exercise devices themselves. Exercise devices may be provided measurement sensors and computing devices that produce information for the users on their exercises, for example. However, each manufacturer of a smart exercise device tend to use their own approach for measuring and presenting data, and thus, the information received by the user is often poorly combinable between devices of different manufacturers. In addition, manufacturing and maintenance costs of a smart exercise device is typically significantly higher than the costs of a conventional exercise device.

Another approach is to bring monitoring capabilities to a conventional exercise device in the form of an addon measurement device. For example, many of exercise devices include a weight stack arrangement with which a user can choose the total weight used during the exercise. A measuring device may be configured such that it can be inserted to the selector hole of the weight plate instead of a conventional selector pin. The measuring device can determine an estimate of the chosen total weight based on mechanical stress on the measuring device caused by the selected weight plates. However, even with this approach, it may be difficult to achieve consistent measurements in different weight stack arrangements of different types of exercise devices. Further, weight stack arrangements manufactured by different manufacturers may have different dimensions and tolerances for said dimensions. As a result, obtaining consistent, reliable measurement results from different exercise devices with one measurement device may be very challenging.

### BRIEF DISCLOSURE

An object of the present disclosure is to provide a selector pin so as to alleviate the above disadvantages. The object of the disclosure is achieved by selector pin and bolt element of a selector pin which are characterized by what is stated in the independent claims. The preferred embodiments of the disclosure are disclosed in the dependent claims.

A selector pin according to the present disclosure acts as a measuring device that determines an estimate of the chosen weights in a weight stack based on the mechanical stress on it caused by the weight stack. One aspect of the selector pin according to the present disclosure is structural features of its bolt element. The bolt element can be designed such that only specific contact points on it engage with the weight stack. As a result, more accurate and consistent measurement results can be achieved on a high variety of different weight exercise devices. Another aspect of the selector pin is implementation of orientation-correcting features. For example, the handle element and/or the bolt element designed such that an orientation of the selector pin deviating from a desired orientation results in a torque that acts to turn the selector pin to the desired orientation. Either of the above-mentioned aspects, i.e. the structural features of the bolt element that improve measurement accuracy and the automatic orientation-correcting features, can be implemented on the selector pin independently from the other. However, said aspects are synergistic, and very high accuracy can be achieved in embodiments where both aspects are present.

### BRIEF DESCRIPTION OF THE DRAWINGS

In the following the invention will be described in greater detail by means of preferred embodiments with reference to the attached drawings, in which

FIGS. 1a to 1c show an example of a weight stack arrangement in which a selector pin according to the present disclosure can be used;

FIGS. 2a to 2c show an embodiment of a selector pin according to the present disclosure;

FIG. 3 shows an embodiment of a bolt element according to the present disclosure; and

FIG. 4 shows another embodiment of a bolt element according to the present disclosure.

### DETAILED DISCLOSURE

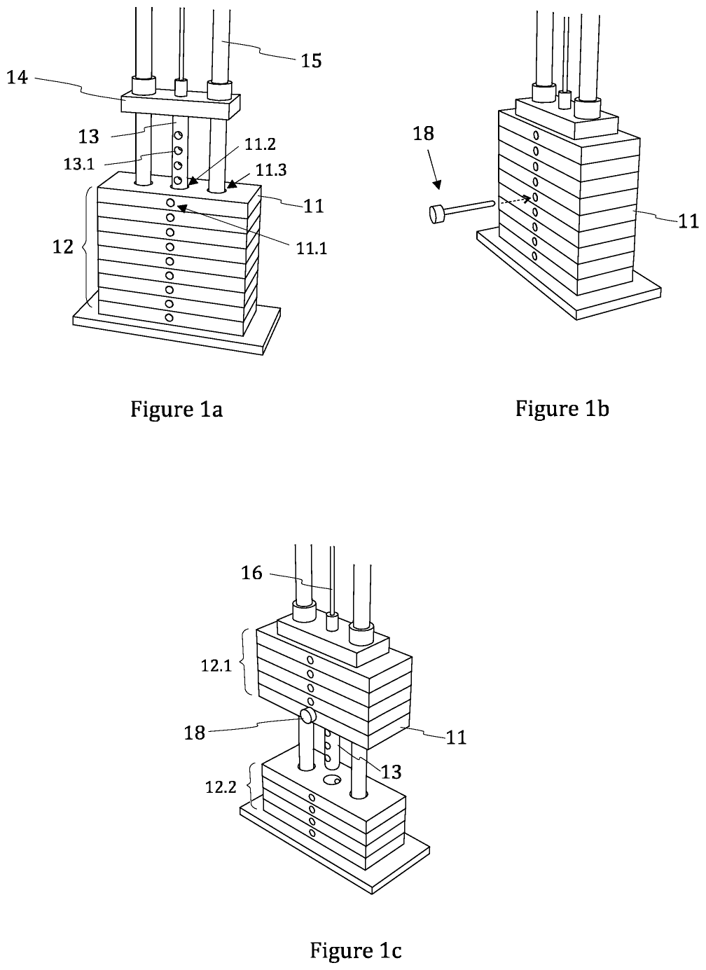

The present disclosure describes a bolt element of selector pin to be used in a weight stack arrangement of a weight exercise machine. A weight stack arrangement typically comprises a weight stack (i.e. a stack of weight plates), a support frame, and an elevator mechanism. FIGS. 1a to 1c show operation of an exemplary weight stack arrangement. In FIG. 1a, weight plates 11 have been stacked into a weight stack 12. Each weight plate 11 is provided three vertical holes, thereby forming three continuous holes running through the whole weight stack 12. Two outermost vertical holes 11.3 accommodate two guide shafts 15 that form a support frame that limits motion of the weight plates to one dimension that typically coincides with the direction of gravity. A middle vertical hole 11.2 is configured to receive a selector shaft 13 therein. In FIGS. 1a to 1c, the selector shaft 13 is attached to a top plate 14 of the weight stack. The top plate is connected to a cable 16 generating an upward-pulling force to top plate 14 in response to user actions during an exercise. Together the selector shaft 13, the top plate 14 and the cable 16 form an elevator mechanism of the weight stack arrangement.

The weight plates 11 and the selector shaft 13 are provided with horizontal selector holes 11.1 and 13.1 so that a desired number of weight plates of the weight stack can be selected for an exercise by inserting a selector pin (i.e. a “weight pin”, a “stack pin”) through the holes 11.1 and 13.1. FIG. 1b shows the top plate 14 resting on top of the weight stack. The selector shaft 13 is completely embedded within the selector shaft hole 11.2, and the holes 13.1 of the selector shaft 13 coincide with selector holes 11.1 of the weight plates 11, thereby forming a continuous hole. In this manner, a selector pin can be easily inserted to the holes.

In FIG. 1b, a conventional selector pin 18 is being inserted to the selector hole of one of the weight plates 11. FIG. 1c shows the selector pin 18 in the selector hole of a weight plate 11. The selector pin 18 attaches the weight plate 11 (and weight plates resting on said weight plate) to a selector shaft 13. A force acting on the cable 16 pulls the top plate 14 and the selector shaft 13 upwards. As a result, the selector shaft 13, and thus, a portion 12.1 of the weight stack is lifted upwards. The guide shafts 15 constrict the movement to one direction. Another portion 12.2 of the weight stack remains at the base of the weight stack arrangement.

As explained above, the selector pin is used to select an effective load to be used in the exercise device. In the context of the present disclosure, the term “effective load” (or “weight load” or simply “load”) refers to a resistance resisting actions of a user using the exercise device. In the example of FIGS. 1a to 1c, the resistance results from a selected portion of the weight stack. However, the term “resistance” is not to be confused with electrical resistance that is also discussed later in this disclosure in relation measurement of mechanical strain with a strain sensor.

In order to monitor physical exercise of a person on weight exercise machine, a selector pin according to the present disclosure may be used instead of a conventional selector pin. While the selector pin according to the present disclosure is mostly discussed in reference to the weight stack arrangement of FIGS. 1a to 1c, use of the selector pin is not limited only to weight stack arrangement according to FIGS. 1a to 1c. Further, while the selector pin is mostly discussed in relation to dynamic exercises where weights moving (e.g. in a reciprocating motion), term “physical exercise” (or simply “exercise”) also includes static exercises where weight plates do not move.

The present disclosure mainly discusses the selector pin in the context of a method comprises a step performing a dynamic or static exercise with the exercise device while estimating the effective load (i.e. the resistance resulting from the selected portion of the weight stack). However, the use of the selector pin according to the present disclosure is not limited only to such scenarios. Instead, the present disclosure also more generically describes a method for an exercise device with a weight stack, where a desired portion of a weight stack can be selected with a selector pin with a bolt element according to the present disclosure. The method comprises at least a step of providing a selector pin with the bolt element according to the present disclosure and a step of selecting a desired portion of the weight stack with the selector pin and measuring the mechanical stress of the bolt element with the stress sensor of the bolt element.

The use of the selector pin is not limited only to measurements measured during with the exercise. For example, the selector pin may be used to measure user performance prior and after an exercise in order to evaluate fatigue caused by the exercise. In this scenario, it may not be necessary to make measurements during the exercise.

Further, as will become apparent later in the present disclosure, the selector pin may be used as a tool for more extensive monitoring and analysing of exercises (dynamic, static, and any combination thereof) and for providing feedback on the exercises.

In addition, the selector pin according to the present disclosure may also be used for testing purposes. For example, with the selector pin actual weight values of a weight stack may be tested and validated.

A selector pin according to the present disclosure may comprise a bolt element and a handle element at one end of the bolt element. In this context, a bolt element is an element in the form of an elongated, essentially straight bar or bolt that is configured to fit in selector holes or slots of a weight plate and a selector shaft of the weight stack arrangement. A selector pin according to the present disclosure preferably comprises means for estimating the amount of weights being used in an exercise. The amount of weight can be estimated by using a stress sensor to determine mechanical stress the selector pin experiences during the exercise. On one hand, the mass of the weights (e.g. in the form of weight plates of a weight stack) generate a downward force. On the other hand, a user exercising on a weight exercise generates a force that is transformed by the elevator mechanism of the weight stack arrangement into an upward force countering (or exceeding the downward force). These forces cause mechanical stress to the bolt element. The mechanical stress, when measured, can be used for estimating an effective load (i.e. resulting from the selected portion of the weight stack). Further, when coupled with other kind of measurements (e.g. acceleration measurements), very versatile measurement data on the exercise can be generated.

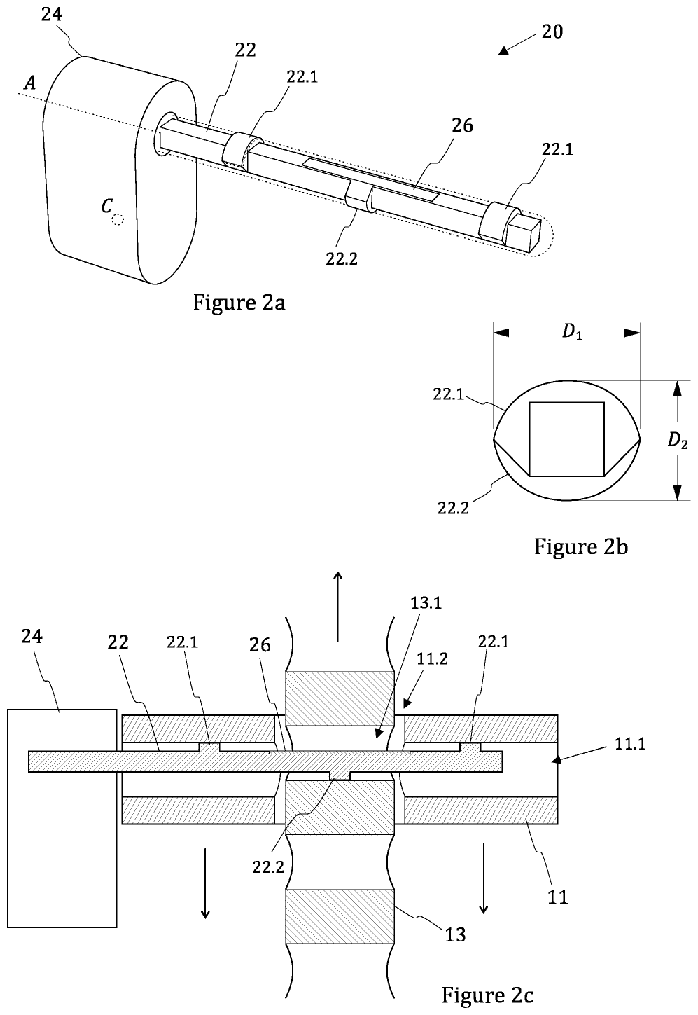

In order to make the mechanical stress measurable, the bolt element may be configured to be elastic and reversibly deformable. However, at the same time, the bolt element should withstand total weight of all weight plates of the weight stack without plastic deformation or breaking). To be able to measure the mechanical stress more accurately, a bolt element according to the present disclosure may have two first contact points positioned along the length of the bolt element on a first side of the bolt element, and a second contact point between the first contact points on a second side opposite to the first side. In the context of the present disclosure, the term “contact point” is intended to be understood as a designated, portion of the bolt element, configured to be in contact with the weight plate and the selector shaft during use. FIGS. 2a to 2c show an exemplary embodiment of a bolt element according to the present disclosure. In FIG. 2a, a selector pin 20 is shown. The selector pin 20 comprises a bolt element 22 and a handle element 24. The bolt element 22 has two first contact points 22.1 on its top side and one second contact point 22.2 on its bottom side.

In the bolt element according to the present disclosure, the first contact points may be configured to engage with the weight plate during an exercise, while the second contact point may be configured to engage with the centre selector shaft. For example, in FIG. 2a, the first contact points 22.1 may be configured to engage with a top portion of an interior surface of the selector hole of the weight plate (e.g. selector hole 11.1 in FIGS. 1a to 1c). The second contact point 22.2 may be configured to engage with a bottom portion of the interior surface of a selector hole of the selector shaft (e.g. selector hole 13.1 in FIGS. 1a to 1c), for example. As a result, a selected portion of the weight stack rests on the first contact points 22.1 of the bolt element 22, while the bolt element 22 itself is supported by the selector shaft at the second contact point 22.2. A cross section of the bolt element is preferably at least approximately circular (or elliptical) as selector holes in most weight stack arrangements are circular. At least part of the bolt element may be coated with a protective coating. The protective coating preferably does not significantly affect the stiffness of the bolt element but protects the stress sensor (and its wiring) from wear and tear. While circular and elliptical cross-sectional shapes are presented as preferable options above, the bolt element according to the present disclosure can be formed with a different shape of cross section. For example, a triangular, rectangular, or hexagonal cross-sectional shape may be used instead.

In order to ensure that the designated contact points engage with the weight plate and the selector shaft and that essentially the whole load of the selected weight plates is carried by the contact points, the contact points may be elevated from the surface of the bolt element. An elevation may be in the form of a bulge, a bump, or other kind of protrusion, for example. At least one of the first and second contact points may be in the form of such protrusions, extending from the first and second side, respectively. Preferably, at least the first contact points are elevated. Most preferably, all contact points (including the second contact point) are elevated.

Protrusions as discussed above can be formed in different ways. For example, protrusions can be formed by adding material to the surface of the bolt element at the contact points. Alternatively, or in addition, protrusions can be formed by removing material (e.g. by cutting or machining) around the contact points.

To produce a measurement signal representing the mechanical stress experienced by the bolt element, the bolt element may further comprise a stress sensor configured to determine mechanical stress of the bolt element caused by forces generated by the weight plate and the selector shaft acting on the first and second contact points of the bolt element. The stress sensor may be connected to a measurement unit that measures a signal generated by the stress sensor. In some embodiments, the measurement unit is fitted inside the handle element of the selector pin. The measurement unit may comprise an A/D converter, a computing device, a power source (such as a battery) and a wireless transceiver, for example. The computing device may be in the form of a processor and a memory, for example.

Within the context of the present disclosure, the term “stress sensor” refers generically to any sensor that can be used to determine mechanical stress of the bolt element, can be fitted on or inside the bolt element, and is able to produce an electrically measurable signal representing the mechanical stress. Preferably, a strain gauge is used as the stress sensor. A strain gauge may be in the form of a foil attached to the bolt element. Conductor traces on the foil are configured to shorten or lengthen (and at the same time become thicker or thinner) as the object is deformed, thereby causing the electrical resistance of the conductors to change. This change of electrical resistance can then be measured, and an estimate of the strain can be formed based on the measured change of electrical resistance. In FIGS. 2a and 2c, a strain gauge 26 is positioned between the first contact points 22.1. The strain gauge 26 is attached to the first side of the bolt element 22. The strain gauge 26 extends along the length of the bolt element 22 and is configured to measure an elastic deformation of the bolt element 22. In this context, elastic deformation is intended to be understood as temporary deformation (e.g. deflection) caused by forces generated by the weight plate and the selector shaft engaging with the first contact points 22.1 and second contact point 22.2. FIG. 2c shows a cross-sectional diagram of interaction between the bolt element 22, a weight plate 11 (e.g. as shown in FIGS. 1a to 1c), and a selector shaft 13 (e.g. as shown in FIGS. 1a to 1c). In FIG. 2c, the bolt element 22 is inside a continuous horizontal hole formed by the selector holes 11.1 and 13.1 of the weight plate 11 and the selector shaft 13. The weight plate 11 rests on the first contact points 22.1. The weight plate 11 (and any other weight plates above it) cause a downward force distributed between the first contact points 22.1. At the same time, a user performing an exercise generates an opposing, upward force to the second contact point 22.2 via the selector shaft 13. Together the downward force at the first contact points 22.1 and the upward force at the second contact point 22.2 cause the bolt element to deform perpendicularly to its length.

In FIGS. 2a to 2c, the bolt element according to the present disclosure is a monolithic structure. However, a bolt element according to the present disclosure is not limited only to such structures. For example, in some embodiments, the strain gauge may be embedded within said bolt element. A middle portion of the bolt element may be longitudinally divided into two separate portions. One of the portions is configured to elastically deform in response to the forces acting on the first and second contact points. The strain gauge may be arranged to measure the elastic deformation of said portion. The cut or cavity dividing the bolt element into the two halves may have been machined, cut, laser-cut, or otherwise formed to the bolt element.

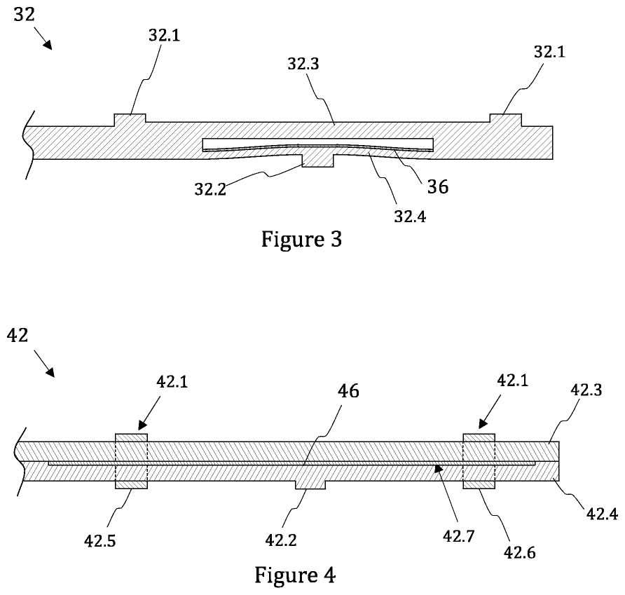

FIG. 3 shows a cross-sectional view of an exemplary bolt element 32 partially divided into two halves. Similar to the embodiment of FIGS. 2a to 2c, the bolt element 32 has two first contact points 32.1 and one second contact point 32.2. However, in contrast to FIGS. 2a to 2c, the middle portion of the bolt element 32 is divided into two longitudinal sections 32.3 and 32.4. In some embodiments, both longitudinal sections are configured to deform elastically in response to mechanical stress. In FIG. 3, however, only the longitudinal section 32.4 to which the second contact point 32.2 is connected deforms in response to mechanical stress. The other section 32.3 may be essentially rigid.

FIG. 4 shows another embodiment where a bolt element 42 is made of two separate halves: a first half 42.3 and a second half 42.4. The halves 42.3 and 42.4 are attached together with two sleeves 42.5 and 42.6 that form closed loops around the halves. Portions of the sleeves 42.5 and 42.6 on the side of the first half 42.3 of the bolt element act as first contact points 42.1 according to the present disclosure. The second half 42.4 may be provided with a protrusion acting as the second contact point 42.2, e.g. as shown in FIG. 4. A stress sensor, such as a strain gauge, may be embedded within one of the halves. For example, one of the halves may have an elongated recess on its surface that faces the other half, and a strain gauge may be arranged within said recess. In FIG. 4, a stress sensor 46 is positioned with a recess 42.7 in the second half 42.4. The recess and the stress sensor may extend along most of the length (or essentially the whole length) of the second half. In this manner, significance of possible misalignment of the bolt element (in the direction of the length of the bolt element) can be reduced. In width-wise direction, the recess and the stress sensor may be narrower than width of the second half. Portions of the second half on both (width-wise) sides of the recess may form rails abutting the first half.

FIGS. 2a to 2c, 3 and 4 discuss embodiments with contact points protruding from the surface of the bolt element. However, the bolt element according to the present disclosure is not limited to such embodiments. Although the protrusions help in minimizing the effects of possible misalignment of the bolt element and possible differences in dimensions of different training devices, the required measurement accuracy depends on the application. For example, in some applications, it may be sufficient to be able to determine a very crude estimate of the effective load and use it to count repetitions during an exercise. This can be performed without high-accuracy measurements.

In addition, some embodiments of a bolt element according to the present disclosure can produce a sufficient measurement accuracy even without the protrusions. For example, a bolt element with a stress sensor extending most (or essentially the whole) length of the bolt element, such as in the embodiment of FIG. 4, can produce sufficiently accurate measurements for estimating effective load even without protruded contact points.

While FIGS. 2a to 2c, 3 and 4 mostly discuss the use of a strain gauge as the stress sensor, the bolt element according to the present disclosure is not limited only to embodiments with strain gauge. Alternatively, other kind of stress sensors, such as a pressure sensor, may be used. Further, the structure of the bolt element is not limited to those presented in FIGS. 2a to 2c, 3 and 4.

For example, in some embodiments, the bolt element may be in the form of a thin, hollow cylinder filled with a fluid. The fluid is preferably essentially incompressible, e.g. pneumatic oil. Forces caused by the weight plates and the selector shaft engaging with the bolt element cause an increase in the pressure of the fluid, and the bolt element may be provided a pressure sensor configured to sense the pressure. In this manner, amount of mechanical stress experienced by the bolt element can be estimated. Similar to the embodiment discussed earlier, the bolt element is preferably provided dedicated contact points: two first contact points positioned along the length of the bolt element on a first side of the bolt element, and a second contact point between the first contact points on a second side opposite to the first side. Further, at least one of the first and second contact points may be in the form of protrusions extending outwards from the shell of the hollow bolt element. Preferably, at least the first contact points are elevated from the surface of the shell. Most preferably, all contact points (including the second contact point) are elevated from the shell surface.

Most of the above-discussed embodiments of a bolt element according to the present disclosure rely on measuring deformation of the bolt element. However, a bolt element according to the present disclosure may also be implemented using other approaches. For example, the bolt element may comprise at least one stress sensor directly at a contact point (i.e. first and/or second contact point) of the bolt element. If the sensors are positioned directly at the contact points as discussed in the two embodiments above, the bolt element itself may be essentially rigid. The at least one stress sensor may be in the form of one or more force-sensing strips or miniature load cell sensors, configured to measure compressive force at the contact points of the bolt element, for example. An estimate of the effective load can be determined based on the measured compressive force.

For example, in some embodiments, a force-sensing strip may be attached on top of one or more contact points. At least one of the contact points may be in the form of protrusions extending outwards from the surface of the bolt element. Preferably, at least the first contact points are elevated from the surface. Most preferably, all contact points (including the second contact point) are elevated from the shell surface. In some embodiments, an elevation may be achieved by positioning a sufficiently thick force-sensing strip on non-protruded contact point of a bolt element. Alternatively, if more prominent elevations are desired, protrusions may be formed on the surface of the bolt element (e.g. similar to the contact points 22.1 and 22.2 in FIGS. 2a to 2c). In other embodiments, one or more miniature load cell sensors may be embedded to one or more contact points of the bolt element. As in the previous embodiment, the bolt element may be configured such that a load cell sensor directly engages with the weight plate and/or the selector shaft. For example, the load cell sensor may be in the form of a button with a stud on one of its faces. The sensor may be embedded within the bolt element such that the stud of one or more load cell sensors contacts the weight plate and/or the selector shaft during use.

The above-discussed embodiments discuss determining the amount of stress in one dimension. This kind of approach has the advantage that it requires fewer stress sensors (e.g. strain gauges). As a result, it may be easier and cheaper to implement. Further, as fewer sensors are fitted to the bolt element, it may be easier to ensure sufficient strength (stiffness) and mechanical robustness of the pin. However, when the measurement of stress is limited to one dimension, the measurement may become more prone to measurement errors caused by incorrect orientation of the selector pin. At an orientation perpendicular to the intended orientation, the stress sensor may be almost completely unresponsive to the mechanical stress. In order to ensure accurate measurement of mechanical stress caused to the selector pin, the selector pin may comprise means for correcting its own orientation. In the following, some examples of these orientation-correcting functionalities are discussed in more detail.

In some embodiments, automatic orientation-correcting functionalities of a selector pin may be implemented with structural features of its handle element. For example, the centre of gravity of the handle element may be arranged to be at a distance from (i.e. does not coincide with) a centre axis of the bolt element. For example, a battery of the selector pin may be positioned at a distance from the centre axis. In this manner, the centre of gravity may be shifted further away from the centre axis of the bolt element. By arranging the centre of gravity to be at a distance from the centre axis of the bolt element, a torque leveraging the selector pin can be caused. This torque acts to turn the selector pin to an orientation where the centre of gravity of the handle element is directly below the centre axis of the bolt element. In FIG. 2a, a centre of gravity C is shown to be at a distance from the centre axis A of the bolt element.

Alternatively, or in addition, the bolt element may implement structural features that act to turn the selector pin to a desired orientation. Shapes and/or relative positions of surfaces of the first and second contact points may be configured such that, when an orientation of the selector pin about the centre axis of the bolt element deviates from a desired orientation during use, forces generated by the weight plate and the selector shaft engaging with the contact points cause a torque that acts to turn the selector pin to the desired orientation. For example, surfaces of the first and second contact points may be configured such that, in a plane perpendicular the centre axis of the bolt element, the shortest distance between surfaces of the weight plate and the selector shaft engaging with the contact points of the bolt element is achieved when in the desired orientation. FIG. 2b illustrates one embodiment of this approach. In FIG. 2b, a view from the end of the bolt element 22 is shown. In a plane perpendicular to the centre axis, surfaces of the first contact point 22.1 and the second contact point 22.2 form an essentially elliptical shape. The elliptical shape has its longest diameter D1 in a direction perpendicular to the desired orientation and the shortest diameter D2 in the direction of the desired orientation. Thus, if the selector pin 22 is not in its desired orientation, the opposing forces caused by the weight plate and the selector shaft acting on the contact points 22.1 and 22.2 cause a torque that acts to turn the bolt element 22 to the desired orientation.

The automatic orientation-correcting features discussed above in relation to the embodiment of FIG. 2a to 2c can also be applied to all other embodiments according to the present disclosure.

In addition to a stress sensor, a selector pin according to the present disclosure may comprise other sensors. For example, the selector pin may further comprise an orientation sensor configured to sense the orientation of the bolt element with respect to the direction of gravity. The orientation sensor may be in the form of an acceleration sensor, for example. The acceleration sensor is preferably at least a 2D accelerometer. The accelerometer may be a MEMS accelerometer, for example. However, other orientation sensors may be used instead. For example, various gravity-assisted mechanical arrangements may be used for determining the selector pin's orientation with respect to the horizontal plane.

The computing device of the measurement unit may be configured to receive measurement signals from the stress sensor and the orientation sensor and calculate an estimate of a total weight of selected by the user on the weight exercise device based on the measurements from the strain gauge and the orientation sensor. Calculating the estimate may comprise steps of estimating total weight based on the strain gauge measurements and compensating the total weight based on the orientation sensor measurements, for example. In this manner, any deviation remaining in orientation of the selector pin (after automatically correcting the orientation) can be compensated. In some embodiments, the selector pin is implemented without any automatic orientation-correcting features, and the determining of value of the selected weight may be based solely on compensating the deviation via calculation.

As an alternative (or in addition) to automatic orientation-correcting features, the selector pin may comprise user-assisted orientation-correcting features. For example, the selector pin may further comprise at least one indicator element, such as a speaker, one or more LEDs or a display. In some embodiments, the computing device of the measuring unit may be configured to produce indicators on the at least one indicator element based on the measurements from the orientation sensor. Alternatively, the indicator element may be a simple, passive indicator (e.g. an arrow formed on the surface of the handle element) indicating which part of the selector pin should be pointing down (or up). The indicator or indicators provide information aiding a user to orient the selector pin to a desired orientation (e.g. by manually turning the selector pin in the selector hole to the desired orientation). In this manner, the user is able to orient the selector pin correctly, if automatic orientation-correcting features of the selector pin fail to do so, or, in some embodiments, if automatic features are not present.

With a selector pin comprising a stress sensor as described in the above embodiments, an estimate of effective weight load used on a weight exercise device during an exercise can be formed. Further, when coupled with measurement data from an acceleration sensor, very versatile information on the exercise can be produced. For example, estimates on how much work was done (i.e. how much energy was consumed) during an exercise and how efficiently the exercise was performed can be formed based on the estimated effective load and acceleration. Estimates may be formed even for each repetition of a movement in an exercise.

A computing device of the selector pin may be configured to provide feedback for the user on an indicator element in the selector pin. This indicator element may be the same indicator element that was used for prompting the user to orient selector pin correctly. Alternatively, a different indicator element may be used on the selector pin. In addition, as briefly mentioned earlier, the selector pin may comprise a wireless transceiver (or a wireless transmitter). A computing device on the selector pin may be configured to send measurement information originating from the sensors on the selector pin to an external device capable of receiving said data via the wireless transceiver. The external device may be a computer, a mobile phone, a fitness tracker watch, or a tablet computer, for example. A selector pin according to the present disclosure may be configured to determine the mechanical stress of the bolt element and/or the orientation of the selector pin and send it to the external device for further processing and analysis. The external device may then be used to display the processed and analysed data. The selector pin may be configured to send the measurement data to the external device in real time or to store data to a memory and send it to the external device later. In order to save battery power, computationally more intensive tasks may be performed on the external device, while the computing unit of the selector pin may be configured to perform only light computational tasks, such as pre-processing of the measured data. Alternatively, the computing device of the selector pin may be configured to implement the functionalities of further processing and analysing of the measured data and the indicator unit of the selector pin may be in the form of a display configured to display feedback on the processed and analysed data.

While the selector pins in the above-discussed embodiments all comprise a stress sensor of some kind, a selector pin according to the present disclosure may also be implemented without a stress sensor. For example, in some embodiments, the selector pin may comprise an acceleration sensor and the selector pin may be configured to provide information on user actions during a weight exercise device based on the acceleration sensor. For example, the selector pin may be configured to produce information number and speed of repetitions in an exercise. The use of an orientation-correcting feature according to the present disclosure (e.g. in the form of an automatic orientation correcting feature and/or a feature prompting user to correct the orientation) is preferable even in embodiments where no stress sensor is used. By having an orientation-correcting feature, effects of gravity to measurements produced by the acceleration sensor can be compensated more easily, or the measurements can be used without compensation.

It is obvious to a person skilled in the art that the selector pin and its bolt element can be implemented in various ways. The invention and its embodiments are not limited to the examples described above but may vary within the scope of the claims.

1. A bolt element of selector pin for a weight stack of a weight exercise machine, wherein the bolt element (22) is configured to fit in selector holes or slots of a weight plate and a selector shaft of the weight stack for selecting a portion of the weight stack for an exercise, and wherein the bolt element has
two first contact points (22.1) positioned along the length of the bolt element (22) on a first side of the bolt element (22), the first contact points (22.1) being configured to engage with the weight plate during the exercise,
a second contact point (22.2) between the first contact points on a second side opposite to the first side, the second contact point (22.2) being configured to engage with the centre selector shaft during the exercise, and
a stress sensor for determining mechanical stress of the bolt element caused by forces generated by the weight plate and the selector shaft acting on the first and second contact points (22.1; 22.2) of the bolt element (22) during the exercise.

2. A bolt element according to claim 1, wherein at least one of the first and second contact points (22.1; 22.2) are in the form of protrusions extending from the first and second side, respectively.

3. A selector pin for a weight stack of a weight exercise machine, wherein the selector pin (20) comprises
a bolt element (22) according to claim 1, and
a handle element (24) at one end of the bolt element (22).

4. A selector pin according to claim 3, wherein the stress sensor is a strain gauge (26) positioned between the first contact points (22.1), the strain gauge (26) extending along the length of the bolt element (22) and being configured to measure an elastic deformation of the bolt element (22) caused by forces generated by the weight plate and the selector shaft acting on the first and second contact points (22.1; 22.2) of the bolt element (22).

5. A selector pin according to claim 4, wherein the strain gauge (26) is attached to the first side of the bolt element (22).

6. A selector pin according to claim 4, wherein the strain gauge (36) is embedded within the bolt element (32).

7. A selector pin according to according claim 6, wherein
a middle portion of the bolt element is longitudinally divided into two separate portions (32.3; 32.4), wherein one of the portions is configured to elastically deform in response to the forces acting on the first and second contact points (32.1; 32.2),
the strain gauge (36) is arranged to measure the elastic deformation of said portion.

8. A selector pin according to claim 3, wherein at least part of the bolt element (22; 32) is coated with a protective coating.

9. A selector pin according to claim 4, wherein
selector pin further comprises
an orientation sensor configured to sense the orientation of the bolt element with respect to the direction of gravity; and
a computing device configured to
receive measurements from the strain gauge (26; 36) and the orientation sensor,
calculate an estimate of a total weight of selected by a user on the weight exercise device based on the measurements from the strain gauge (26; 36) and the orientation sensor.

10. A selector pin according to claim 9, wherein
the selector pin further comprises at least one indicator element, and
the computing device is further configured to
show indicators on the at least one visual indicator element based on the measurements from the orientation sensor, wherein the showed indicators provide information aiding a user to orient the selector pin to a desired orientation.

11. A selector pin according to claim 4, wherein
the centre of gravity of the handle element (24) is at a distance from a centre axis of the bolt element (22) so as to cause a torque that rotates the selector pin towards an orientation where the centre of gravity of the handle element (24) is directly below the centre axis of the bolt element (22).

12. A selector pin according to claim 11, wherein a battery of the selector pin is positioned at a distance from the centre axis.

13. A selector pin according to claim 1, wherein
shapes and/or relative positions of surfaces of the first and second contact points (22.1; 22.2) are such that, when an orientation of the selector pin about the centre axis of the bolt element (22) deviates from a desired orientation during use, forces generated by the weight plate and the selector shaft engaging with the contact points (22.1; 22.2) cause a torque that acts to turn the selector pin to the desired orientation.

14. A method for an exercise device where a desired portion of a weight stack can be selected with a selector pin, wherein the method comprises:
providing a selector pin with a bolt element according to claim 1,
selecting a desired portion of the weight stack with the selector pin and measuring the mechanical stress of the bolt element with the stress sensor of the bolt element.

15. A method according to claim 14, wherein the method comprises:
performing a dynamic or static exercise with the exercise device while estimating an effective load resulting from the selected portion of the weight stack
